(19) United States
(12) Patent Application Publication
(10) Pub. No.: US 2003/0127449 A1
(43) Pub. Date: Jul. 10, 2003

(54) Method and device for heater control in drying apparatus

(76) Inventor: Soon Jo Lee, Kyongsangnam-do (KR)

Correspondence Address: Song K Jung, McKenna Long & Aldridge, 1900 K Street NW, Washington, DC, 20006, US

(21) Appl. No.: 10/296,821

(22) PCT Filed: Mar. 29, 2002
(86) PCT No.: PCT/KR02/00552

(30) Foreign Application Priority Data
Mar. 29, 2001 (KR) 2001/16564

(51) Int. Cl. H05B 1/02

(52) U.S. Cl. 219/483; 219/486; 219/484

(57) ABSTRACT

A device and method for controlling a heater of a drying machine is disclosed, which includes a plurality of switches, each switch having a plurality of input terminals being supplied with different input voltages and an output terminal, and each switch connecting any one of the input terminals with the output terminal according to a switching control signal, and a heater connected to the output terminal of each switch and varying its temperature according to the input voltage being supplied thereto.

### TECHNICAL FIELD

The present invention relates to a device for controlling a heating device, and more particularly, to a method and a device for controlling a heater of a drying machine.

### BACKGROUND ART

The development in the semiconductor technology and the scientific technology has brought about many changes in the actual life, which can be seen in our surroundings. This is mainly due to a diversification of products and broad and various application of multimedia thereto, such as Internet televisions, Internet refrigerators, and washing machines with drying functions.

With the advent of such changes, consumers have become deeply interested in energy efficiency of such appliances. More specifically, a consumer rates the reliability and quality of the product depending on its level of energy efficiency and the level of reliability of its inner components. Furthermore, the government decides a standard energy efficiency level. Thus, the products that do not meet with the standard level cannot be sold in the market.

Therefore, the manufacturers and the distributors are allowed to sell their products only if the products pass the standard level of energy efficiency prescribed by the government. Also, the users and the consumers may become more satisfied by purchasing a product of high energy efficiency.

More specifically, the present invention relates to enhancing energy efficiency and product reliability in a device for controlling the heater of a drying machine.

The process of operating a related art drying machine will be described with reference to FIG. 1.

FIG. 1 illustrates a structure of a general drying machine. As shown in FIG. 1, an outcase 1 forms an outer shape of the drying machine. A front plate 3 is connected and fixed on the outcase 1, so as to form the front surface of the drying machine.

A drum 5 is fixed inside the outcase 1, so as to rotate during the course of a drying process. Wet laundry is introduced to the drum 5 prior to the drying process. A plurality of stirring blades 6 are formed inside the drum 5. The stirring blades 6 evenly stir the laundry while the drum 5 rotates. A belt 7 is formed on the circumference of the drum 5 so as to rotate the drum 5. A separate motor operates the belt 7, which drives the drum 5.

Meanwhile, a door 8 selectively opening and connecting the inside and the outside of the drum 5 penetrates the front plate 3, which corresponds to the front portion of the drum 5 and fixed thereon. A discharge hole 10 corresponding to the inside of the front plate 3 and opening towards the inside of the drum is also formed. The discharge hole 10 discharges the air existing inside the drum 5 to the outside. A filter 12 is formed on the hole in order to remove impurities within the air.

A discharge flow tube 13 connected to the discharge hole 10 is formed on the inner surface of the front plate 3. Then, a blower assembly 15 is formed to be connected to the discharge flow tube 13. A discharge duct 17 discharging the air, which is flown through the discharge flow tube 13, to the outside of the drying machine is connected to the blower assembly 15.

Meanwhile, a supply duct 18 supplying air into the drum is formed on a lower portion of the drum 5 inside the outcase 1. The supply duct 18 supplies the air into the drum 5 through the rear side of the drum 5. A heater 19 is fixed on a side of the supply duct 18.

The drying process of the related art drying machine will now be explained.

A user opens the door 8 and puts in wet laundry into the drum 5. The user then closes the door 8 and inputs operation signals for drying, thereby allowing the drum 5 to be rotated by a motor. Subsequently, the blower assembly 15 is operated to discharge the air inside the drum 5 through the discharge duct 17.

When the air inside the drum 5 is discharged, the ambient air outside the drying machine is drawn into the drum 5 through the supply duct 18. Due to the heat from the heater 19 placed at the opening of the supply duct 18, the air outside the drying machine is heated to a set temperature and sent into the drum 5.

The heated air sent into the drum 5 absorbs the humidity within the wet laundry. Due to the operation of the blower assembly 15, the air then flows into the discharge flow 13 through the discharge hole 10. The humid air inside the discharge flow 13 then passes through the blower assembly 15 and the discharge duct 17 in order to be discharged to the outside.

At this point, the filter 12 filters out the air passing through the discharge hole, so as to prevent impurities, such as drawn thread or fuzz, from being sent into the blower assembly 15.

The process of controlling a heater of the related art drying machine will now be described with reference to FIG. 2.

FIG. 2 illustrates a block diagram showing a device for controlling a heater of the related art drying machine.

As shown in FIG. 2, the device for controlling a heater of the related art drying machine includes a thermistor 24 fixed inside the drum 5 and detecting the temperature therein, and a controller 20 inputting the detected temperature and controlling a series of operations related to the drying process of the drying machine. The controller 20 is connected to a first terminal L1 and a second terminal N, both supplying voltage from the outside and to the drying machine. A driving voltage of about 120V is applied to the controller 20, which is connected to the first terminal L1 and the second terminal N.

In addition, the related art drying machine is equipped with a heater 19 carrying out ON/OFF operations, which are controlled by the controller 20. The heater 19 is connected between the first terminal L1 and a third terminal L2, both supplying voltage from the outside and to the drying machine.

With the connection to the first terminal L1 and the third terminal L2, a voltage of about 240V is applied to the heater 19. In order to prevent the heater from being overheated, a thermostat 26 is connected in series with the heater 19 so that the heater 19 may be automatically turned OFF when the temperature reaches a set level.

The process of controlling a heater of the related art drying machine will now be described in detail.

FIG. 3 illustrates a graph showing temperature characteristics according to each type of fabric.

More specifically, as shown in FIG. 3, when the drying operation is carried out, the temperature within the drum 5 should be controlled differently in accordance with the type of fabric. For example, the temperature should be controlled to a set temperature T1 when drying cotton fabric. Also, when drying knitted fabric, the temperature inside the drum 5 should be controlled to another set temperature T3, which is lower than that for cotton fabric.

Therefore, the controller 20 identifies the control temperature of the laundry put into the drum 5 before actually controlling the drying process. The controller 20 sets the control temperature to an appropriate level either when the user selects the type of fabric or when the information corresponding to the fabric of the laundry is received from the washing machine.

Subsequently, when the heater 19 is turned ON and the drying operation begins accordingly, the controller 20 identifies the temperature inside the drum 5 by using the thermistor 24. Afterwards, the heater 19 is turned ON until the inside of the drum 5 reaches the pre-set temperature range, and then the heater is turned OFF.

Therefore, due to the repeated control of the ON/OFF operations of the heater 19, the controller 20 controls the temperature in order to maintain the inside of the drum 5 within the pre-set range.

The heater control for the related art drying machine has the following disadvantages.

In the related art drying machine, a heater 19 connected to a first terminal L1 and a third terminal L2, both supplying from the outside and to the inside of the drying machine, is controlled so that a voltage of about 240V is always supplied to the heater 19, so as to generate a constant amount of power. Therefore, the heater 19 of the related art drying machine is controlled by controlling the ON/OFF state of the heater 19 using the controller 20 in accordance with the temperature detected from the thermistor 24 and the range of temperature pre-set from the thermistor 24. Therefore, in the heater control of the related art drying machine, the frequent ON/OFF control of the heater results in a decrease in energy efficiency.

Additionally, in the related art method for controlling a heater, the ON/OFF state of a heater having a constant output voltage is controlled. Therefore, in order to maintain the temperature at a low level, a frequent control of the ON/OFF operation is inevitable. This decreases the characteristics of drying machine components in a switching device for a heater and a heater control, thereby decreasing the reliability of the product.

### DISCLOSURE OF THE INVENTION

Accordingly, the present invention is directed to a method and device for controlling a heater of a drying machine that substantially obviate one or more of the problems due to limitations and disadvantages of the related art.

An object of the present invention is to provide a method and a device for controlling a heater of a drying machine whereby an output power of a heater is variably controlled, so as to enhance energy efficiency and reliability of the product.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a device for controlling a heater of a drying machine according to the present invention includes a plurality of switches, each switch having a plurality of input terminals being supplied with different input voltages and an output terminal, and each switch connecting any one of the input terminals with the output terminal according to a switching control signal, and a heater connected to the output terminal on each switch and varying its temperature according to the input voltage being supplied thereto.

To further achieve these and other advantages and in accordance with the purpose of the present invention, a device for controlling a heater of a drying machine according to the present invention includes a plurality of switches, each switch having a plurality of input terminals being supplied with different input voltages and an output terminal, and each switch connecting any one of the input terminals to the output terminal according to a switching control signal, a plurality of heaters, each corresponding to each switch and varying its temperature according to an input voltage supplied thereto by each switch, wherein each heater includes a first end and a second end, so that the first end is connected to an output terminal of a switch, and the second end is connected to the second switch of an adjacent heater, and a controller controlling connections of the switches, wherein the controller decides an output voltage of each heater depending on a desired temperature of a drying object corresponding to each laundry type and controls the input voltage being supplied thereto.

Herein, the heaters may be arranged to face into one another. Also, the each switch includes two input terminals.

To further achieve these and other advantages and in accordance with the purpose of the present invention, a device for controlling a heater of a drying machine according to the present invention includes first and second switches, each switch having first and second input terminals being supplied with different input voltages and an output terminal, and each switch connecting either one of the first and second input terminals to the output terminal according to a switching control signal, a first heater connected to the output terminal of the first switch and varying its temperature according to a first input voltage supplied thereto by the first switch, a second heater connected to the output terminal of the second switch and varying its temperature according to a second input voltage supplied thereto by the second switch, wherein each heater includes a first end and a second end, so that the first end of each heater is connected to the output terminal of the switch, and the second end of each heater is commonly connected to one another, and a controller controlling the connection between the first and second switches, wherein the controller decides the output voltage of the first and second heaters depending on a desired temperature of a drying object corresponding to each laundry type and controls the input voltage being supplied to each of the first and second heaters.

Herein, the voltage supplied to the first input terminal is 240V, and the voltage supplied to the second input terminal is 120V.

To further achieve these and other advantages and in accordance with the purpose of the present invention, a method for controlling a heater of a drying machine according to the present invention includes deciding a range of temperatures for a heater according to each type of laundry and an output voltage according to the range of temperatures, selecting the type of laundry to be dried, identifying an output voltage of the heater corresponding to the selected type of laundry, and controlling an input voltage being supplied to the heater according to the identified output voltage.

As described above, the input voltage of the heater is variably controlled, so as to variably control the output voltage of the heater according to the range of temperatures. Therefore, as in the related art, frequent ON/OFF operations of the heater at a low temperature range may be prevented, thereby enhancing a reliability of components in the heater and switching device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a structure of a general drying machine;

FIG. 2 illustrates a block diagram of a device for controlling a heater of the related art drying machine;

FIG. 3 illustrates a graph showing temperature characteristics according to each type of fabric;

FIG. 4 illustrates a block diagram of a device for controlling a heater of a drying machine according to the present invention; and

FIG. 5 illustrates a control table of the heater according to the present invention.

### BEST MODE FOR CARRYING OUT THE INVENTION

Reference will now be made in detail to the preferred embodiments of the present invention, examples of which are illustrated in the accompanying drawings. In describing the identical structures in the present invention, the same terms and numeric references will be used, and some supplementary descriptions will be omitted for simplification.

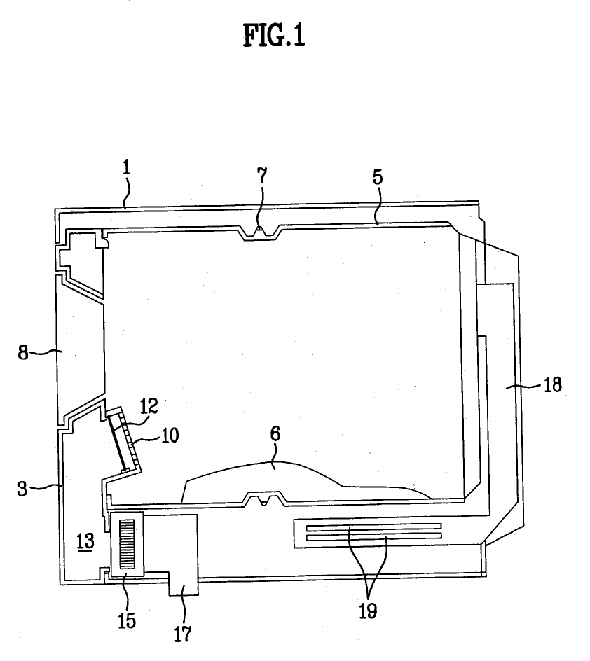

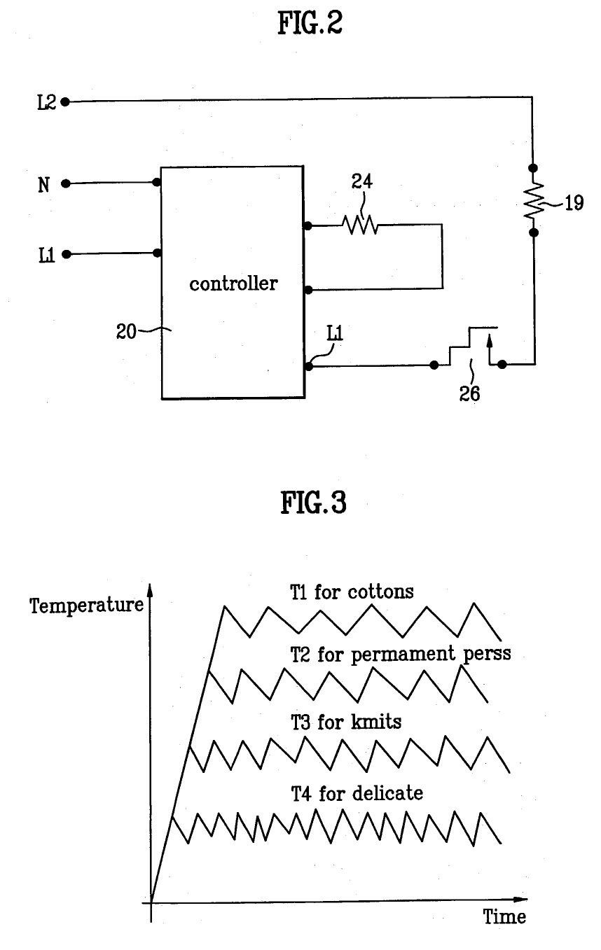

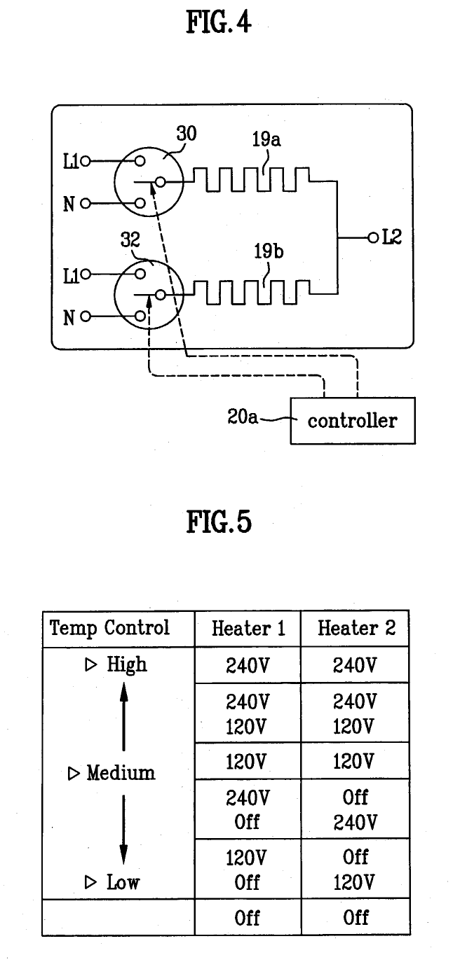

FIG. 4 illustrates a block diagram of a device for controlling a heater of a drying machine according to the present invention. The structure of the heater will be made with reference to FIG. 1.

A device for controlling a heater according to the present invention includes two heaters 19a and 19b connected in parallel. An output voltage being supplied to each of the first and second heaters 19a and 19b is controlled, thus the drying operation is controlled.

One side of the first heater 19a is connected to a third terminal L2, which externally supply input voltages into the drying machine. Another side of the heater 19a is connected to a first relay 30 allowing a selective connection with one of a first terminal L1 and a second terminal N, both of which externally supply input voltages into the drying machine. Therefore, the heater 19a may be connected between the first terminal L1 and the third terminal L2 through the first relay 30. Otherwise, the first heater 19a may be connected between the second terminal N and the third terminal L2 through the first relay 30.

The second heater 19b is formed with a structure similar to that of the first heater 19a. More specifically, one side of the second heater 19b is connected to a third terminal L2, which externally supplies an input voltage into the drying machine. Another side of the second heater 19b is connected to a second relay 32 allowing a selective connection with one of a first terminal L1 and a second terminal N, both of which externally supply input voltages into the drying machine. Therefore, the second heater 19b may be connected between the first terminal L1 and the third terminal L2 through the second relay 32. Otherwise, the second heater 19b may be connected between the second terminal N and the third terminal L2 through the second relay 32.

A controller 20a controls the operation of the first and second relays 30 and 32. The controller 20a decides a range of temperature control according to the type of laundry fabric. The controller 20a then controls the operation of the first and second relays 30 and 32, thereby enabling the voltage output of the heater according to the decided temperature control range.

The control of the first and second relays 30 and 32 according to the temperature control range of the controller 20a is carried out, as shown in FIG. 5. More specifically, when the temperature should be controlled to a high temperature range, a high output control is carried out in the first and second heaters 19a and 19b. However, when the temperature should be controlled to a low temperature range, a low output control is carried out in the first and second heaters 19a and 19b.

Therefore, the controller 20a pre-sets a value for an output control of the heater according to the temperature control range, as shown in FIG. 5. Such control of the output voltage of the first and second heaters 19a and 19b is possible because the input voltage is formed of three levels: 0 V, 120V, and 240V.

The above-described device and method for controlling a heater of the drying machine according to the present will now be described in detail.

A user opens the door 8 to put wet laundry into the drum 5. After shutting the door 8, the user inputs the drying operation signal, which is recognized by the controller 20a. The controller 20a operates the motor, thereby allowing the drum 5 to rotate. Then, the blower assembly 15 is operated, thus the air within the drum 5 is discharged through the discharge duct 17 to the outside.

Meanwhile, the controller 20a decides a range of temperature according to the drying operation based on the type of laundry fabric selected by the user or the information of the laundry fabric provided by the washing machine. When drying laundry that can be processed at a high temperature range, the output voltage of the first and second heaters 19a and 19b is controlled to a high level. Conversely, when drying laundry that should be processed at a low temperature range, the output voltage of the heaters 19a and 19b is controlled to a low level.

Thus, in order to carry out a drying operation within the decided temperature range, the controller 20a controls the switching operation of the first and second relays 30 and 32, thereby enabling the first and second heaters 19a and 19b to generate heat.

At this point, the air within the drum 5 is discharged to the outside, while cool air is drawn-in from the outside through the supply duct 18 and into the drum 5. Due to the heat produced from the first and second heaters 19a and 19b fixed on the opening of each supply duct 18, the air drawn-in is heated to a certain degree before being supplied into the drum 5.

The heated air supplied into the drum 5 dehydrates the laundry and is sent to the discharge flow 13 through the discharge hole 10 due to the operation of the blower assembly 15. The air is then externally discharged from the discharge flow 13 and through the discharge duct 17.

Thus, the circulating movement of heated air allows the wet laundry inside the drum 5 to be dried.

The process of controlling the level of voltage supplied to the first and second heaters 19a and 19b will now be described in detail.

As shown in FIG. 4, a single-phase 3-wire type connection includes a total of three terminals for supplying input voltage (i.e., the first terminal L1, the second terminal N, and the third terminal L2). Each of the three terminals is formed to generate different levels of voltage when connected to one another. When the first terminal L1 is connected to the second terminal N, a voltage of about 120V is produced. Similarly, when the second terminal N is connected to the third terminal L2, a voltage of about 120V is generated. Finally, when the first terminal L1 is connected to the third terminal L2, a voltage of 240V is produced.

Presently, such method for controlling a level of voltage is widely used in the United States. More specifically, a voltage of 120V is used in drying machines having low output, and a voltage of 240V is used in drying machines having high output.

Therefore, in the present invention, the output voltage of the heater may be variably controlled by using different levels of input voltage. In case the input voltage is constant, a structure for transforming current is further included so as to control the input voltage of the heater differently.

More specifically, both the first relay 30 and the second relay 32 are formed to select one of the first terminal L1 and the second terminal N. In addition, the third terminal L2 is commonly connected to the side of both the first and second heaters 19a and 19b. Therefore, the two heaters 19a and 19b may be supplied with either a voltage of 120V or a voltage of 240V, depending on the selection operation of the first relay 30 and the second relay 32.

When the controller 20a connects the first relay 30 and the second relay 32 to the first terminal, both heaters 19a and 19b are connected between the first terminal L1 and the third terminal L2. Therefore, a voltage of 240V is supplied to operate the first and second heaters 19a and 19b.

When the controller 20a connects the first relay 30 to the first terminal L1 and the second relay 32 to the second terminal N, then the first heater 19a is operated with an input voltage of 240V, and the second heater 19b is controlled with an input voltage of 120V. Conversely, when the controller 20a connects the first relay 30 to the second terminal N and the second relay 32 to the first terminal L1, then the first heater 19a is controlled with an input voltage of 120V, and the second heater 19b is operated with an input voltage of 240V.

When the controller 20a connects both the first relay 30 and the second relay 32 to the second terminal N, then the two heaters 19a and 19b are both connected between the second terminal N and the third terminal L2. Therefore, the two heaters 19a and 19b are operated with an input voltage of 120V.

When the controller 20a connects the first relay 30 to the first terminal L1 and turns the second relay 32 OFF, then the first heater 19a is connected to the first terminal L1 and the third terminal L2. Therefore, the first heater 19a is operated with a voltage of 240V. In this case, the second heater 19b is turned OFF.

Conversely, when the controller 20a turns the first relay 30 OFF and connects the second relay 32 to the first terminal L1, then the second heater 19b is operated with a voltage of 240V. In this case, the first heater 19a is turned OFF.

Additionally, when the controller 20a connects the first relay 30 to the second terminal N and turns the second relay 32 OFF, then a driving voltage of 120V is supplied to the first heater 19a. At this point, the second heater 19b is turned OFF. Conversely, when the controller 20a turns the first relay 30 OFF and connects the second relay 32 to the second terminal N, then a driving voltage of 120V is supplied to the second heater 19b. In this case, the first heater 19a is turned OFF.

Furthermore, when the controller 20a turns both the first and second relays 30 and 32 OFF, both heaters 19a and 19b are also turned OFF accordingly.

As described above, in the present invention, the temperature control range for a drying operation is pre-set depending on the type of fabric that is to be dried. Afterwards, an output voltage of the heater based on the preset temperature control range is decided. Then, once the drying operation is initiated, an appropriate output voltage is selected in accordance with the pre-set temperature range.

Industrial Applicability

As described above, the device and method for a heater control in a drying machine according to the present invention has the following advantages.

An input voltage of a heater may be variably controlled, thereby allowing an output voltage of the heater to be variably controlled in accordance with a set temperature range.

The present invention is advantageous in that frequent ON/OFF operations of the heater at a low temperature range may be prevented. Thus, the reliability in the components of the heater and the switching device may be improved.

In addition, the output voltage of the heater according to a set temperature range may be variably controlled even without the frequent ON/OFF operations of the heater. And so, energy efficiency of the present invention may be enhanced.

Finally, with the above-described advantages, reliability and product quality may also be enhanced.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A device for controlling a heater of a drying machine comprising:
a plurality of switches, each switch having a plurality of input terminals being supplied with different input voltages and an output terminal, and each switch connecting any one of the input terminals with the output terminal according to a switching control signal; and
a heater connected to the output terminal of each switch and varying its temperature according to the input voltage being supplied thereto.

2. The device of claim 1, wherein the heaters connected to each of the switches are connected in parallel.

3. The device of claim 1, wherein any one of 0 V, 120V, and 240V is supplied to each of the plurality of input terminals.

4. The device of claim 1, further comprising a controller controlling the plurality of switches in accordance with a desired temperature of a drying object.

5. A device for controlling a heater of a drying machine comprising:
a plurality of switches, each switch having a plurality of input terminals being supplied with different input voltages and an output terminal, and each switch connecting any one of the input terminals to the output terminal according to a switching control signal;
a plurality of heaters, each corresponding to each switch and varying its temperature according to an input voltage supplied thereto by each switch, wherein each heater includes a first end and a second end, so that the first end is connected to an output terminal of a switch, and the second end is connected to the second switch of an adjacent heater; and
a controller controlling connections of the switches, wherein the controller decides an output voltage of each heater depending on a desired temperature of a drying object corresponding to each laundry type and controls the input voltage being supplied to each heater.

6. The device of claim 5, wherein the plurality of heaters are arranged to face into each other.

7. The device of claim 5, wherein each of the plurality of switches includes two input terminals.

8. The device of claim 7, wherein input voltages being supplied to each of the two input terminals are different.

9. The device of claim 8, wherein any one of 0 V, 120V, and 240V is supplied to each of the two input terminals.

10. A device for controlling a heater of a drying machine comprising:
first and second switches, each switch having first and second input terminals being supplied with different input voltages and an output terminal, and each switch connecting either one of the first and second input terminals to the output terminal according to a switching control signal;
a first heater connected to the output terminal of the first switch and varying its temperature according to a first input voltage supplied thereto by the first switch;
a second heater connected to the output terminal of the second switch and varying its temperature according to the second input voltage supplied thereto by the second switch, wherein each heater includes a first end and a second end, so that the first end of each heater is connected to the output terminal of the switch, and the second end of each heater is commonly connected to one another; and
a controller controlling the connection between the first and second switches, wherein the controller decides an output voltage of each of the first and second heaters depending on a desired temperature of a drying object corresponding to each laundry type and controls the input voltage being supplied to each of the first and second heaters.

11. The device of claim 10, wherein the first and second heaters are arranged to face into one another.

12. The device of claim 10, wherein a voltage of 240V is supplied to the first input terminal, and a voltage of 120V is supplied to the second input terminal.

13. A method for controlling a heater of a drying machine comprising:
deciding a range of temperatures for a heater according to each type of laundry and an output voltage according to the range of temperatures;
selecting a type of laundry to be dried;
identifying an output voltage of the heater corresponding to the selected type of laundry; and
controlling an input voltage being supplied to the heater according to the identified output voltage.
